(19) United States
(12) Patent Application Publication
(10) Pub. No.: US 2015/0095061 A1
(43) Pub. Date: Apr. 2, 2015

(54) METHOD AND SYSTEM FOR MANAGING HEALTH INFORMATION BY USING HEALTH-CARE STATION

(71) Applicant: Hongjin Kim, Seoul (KR)

(72) Inventor: Hongjin Kim, Seoul (KR)

(21) Appl. No.: 14/039,203

(22) Filed: Sep. 27, 2013

(51) Int. Cl. G06F 19/00

(52) U.S. Cl. CPC G06F 19/322
USPC 705/3

(57) ABSTRACT

Disclosed is a technology for measuring and managing health information, and more particularly disclosed are a method and a system for managing the health information by using a health-care station. The method for measuring and managing the health information by using the health-care station includes: (i) checking whether or not a health-care station linked application is installed in a health-care station 100 linked personal mobile terminal 200 (s100); (ii) installing the health-care station linked application in the personal mobile terminal 200 when the health-care station 100 linked application is not installed (s200); (iii) executing the health-care station 100 linked application (s300); (iv) linking the health-care station 100 to the personal mobile terminal 200 in which the health-care station 100 linked application has been executed (s400); (v) transmitting measured health information to the personal mobile terminal 200 from the health-care station 100 (s500); and (vi) storing the transmitted health information in the personal mobile terminal 200 (s600).

### BACKGROUND

1. Field

The present invention relates to a technology for measuring and managing health information, and more particularly to a method and a system for measuring and managing health information by using a health-care station.

2. Description of Related Art

In order that patients and people measure health status or receive a variety of health-care services, it is common that they should visit in person medical institutions like a hospital equipped with a lot of medical measurement equipment and should receive the measurement for a long time. The diagnosis of the health status on the basis of the health status measurements obtained from the medical institution requires a long time and asks a user to visit the hospital in person and to receive the health diagnosis result through a consultation with a dedicated medical staffs.

However, for the purpose of preventing lifestyle diseases like high blood pressure, diabetes, fatness and the like, it is important to periodically measure and accumulate his/her own health data anytime and anywhere, and then to early detect and treat the problems through the observation of the change of the health data.

For this purpose, recently, inexpensive measuring devices capable of individually measuring the health status and of always determining whether or not a disease has occurred, without the help of the medical equipment such as a blood pressure monitor, a blood glucose monitor and the like are being developed and commercially used. Each of the unit measuring devices including the blood pressure monitor, the blood glucose monitor, etc., is designed to partially measure only a specific health status of the user, and the user determines freely his/her own health status only by the measurement result of the each unit measuring device. Thus, the user is overconfident in the result, so that there is a possibility that the user rather neglect the periodical health-care service of the hospital for the comprehensive diagnosis of the health status. Besides, the measured data is not accumulated, so that it is not possible to early detect a disease by analyzing the change of the data.

Moreover, each unit measuring device that is optionally easily purchased and used by the user has only a function of partially measuring extremely limited health statuses such as a blood pressure, a blood sugar, etc. Therefore, it is difficult for the user to comprehensively determine the partially measured data and to understand the health status. It is also difficult for the user to objectively and accurately analyze the measured data of the health status. Accordingly, there happen many cases that the measurement is the final step and a systematical health management is not performed.

Here, a method for using a health-care kiosk installed in a place which is easy for the user to access is used. However, a conventional health-care kiosk itself stores the measured personal health information and history and the like or transmits to an external server. Since the kiosk is installed in a public place, etc., other neighboring people are able to check the personal information. As a result, the kiosk is vulnerable to personal information security threats.

### PRIOR ART DOCUMENT

In Korean Patent Number 10-1129329, disclosed is a ubiquitous kiosk system for a gym. More particularly, through a system for managing exercise equipment such as a treadmill, a bike or the like installed in the gym, a personal exercise history of a user is managed, checked and outputted with ease through the kiosk. Also, for a time during which a manager monitors in real time the exercise conditions of the user through a wirelessly connected computer of a management office, when the heart rate of the user exceeds a reference value, the operating level of the exercise equipment can be automatically controlled by a preset program, and it is possible to enjoy multimedia features, e.g., public notice, banner advertisement management, etc., and a variety of contents, for example, biorhythm inquiry, food calorie calculation and the like anywhere within the gym where the kiosk has been installed.

The exercise history (a total exercise time, exercise distance, consumed calorie) of the user can be systematically managed and user-oriented scientific health training can be done on the basis of the systematical management of the exercise history. Anywhere within the gym where the kiosk has been installed, it is possible to inquire the exercise history and to authenticate himself/herself. Also, through the provision of the public notice, banner advertisement management, biorhythm, calorie calculation and other various exercise-related contents, the quality of the gym is improved. A wireless interface through a wireless WiFi modem method removes both cumbersome due to communication line installation construction and inconvenience caused by re-construction at the time of moving the equipment. However, the kiosk is also vulnerable to personal information security threats, and procedures such as user authentication, etc., are inconvenient.

### SUMMARY

### Technical Problem

The present invention provides an easy-to-use technology not only for effectively protecting personal information but also for efficiently managing health information measured by health measuring equipment connected to a health-care station like a kiosk, etc.

### Technical Solution

The present invention provides a method for measuring and managing health information by using a health-care station. The method includes:

(i) checking whether or not a health-care station linked application is installed in a health-care station 100 linked personal mobile terminal 200 (s100);

(ii) installing the health-care station linked application in the personal mobile terminal 200 when the health-care station 100 linked application is not installed (s200);

(iii) executing the health-care station 100 linked application (s300);

(iv) linking the health-care station 100 to the personal mobile terminal 200 in which the health-care station 100 linked application has been executed (s400);

(v) transmitting measured health information to the personal mobile terminal 200 from the health-care station 100 (s500); and

(vi) storing the transmitted health information in the personal mobile terminal 200 (s600).

### ADVANTAGEOUS EFFECT

A conventional health-care station itself, for example, a kiosk, stores measured personal health information and history and the like or transmits to an external server. Since the health-care station is installed in a public place, etc., other neighboring people are able to check the personal information. As a result, the health-care station is vulnerable to personal information security threats.

Contrary to this, according to the present invention, the measured health information is transmitted to and managed in the mobile phone of the user. Therefore, the personal information is never expected to be disclosed and the data is continuously maintained, thereby continuously managing the health. Also, by linking a smart device, it is possible to easily allow the user to easily authenticate himself/herself and to access.

### BRIEF DESCRIPTION OF THE DRAWINGS

FIG. 1 is a conceptual diagram showing a health information management system using a health-care station and a personal mobile terminal in accordance with the present invention;

FIG. 2 is a flowchart for describing a method for measuring and managing the health information in accordance with the present invention;

FIG. 3 is a flowchart for describing another embodiment of the method for measuring and managing the health information in accordance with the present invention;

FIG. 4 is a perspective view of the health-care station of the present invention;

FIG. 5 is a view showing a configuration of the health-care station of the present invention;

FIG. 6 is a view showing a configuration of the personal mobile terminal of the present invention;

FIG. 7 is a view showing a display of the personal mobile terminal of the present invention; and

FIG. 8 is a conceptual diagram for describing another embodiment of the health information management system using the health-care station and the personal mobile terminal in accordance with the present invention.

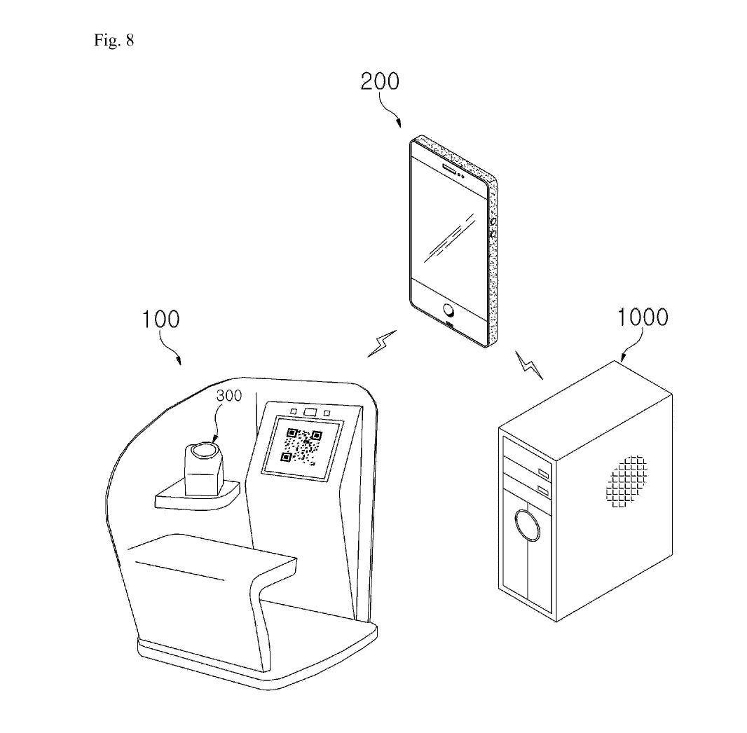

### DETAILED DESCRIPTION

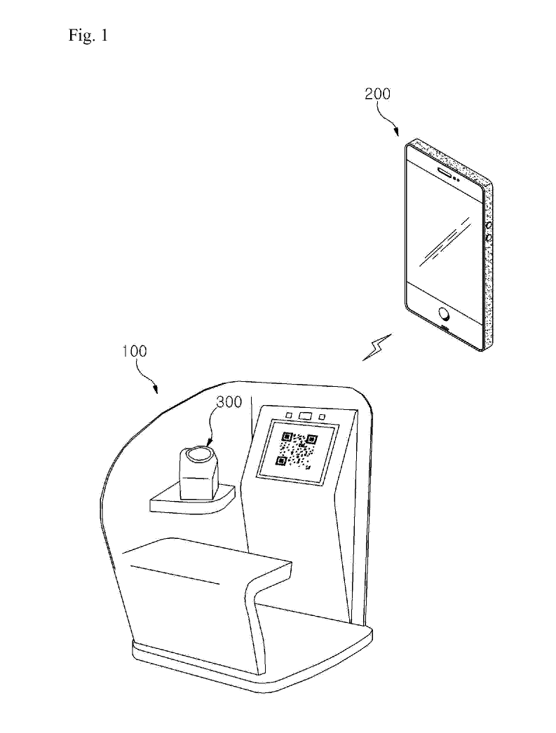

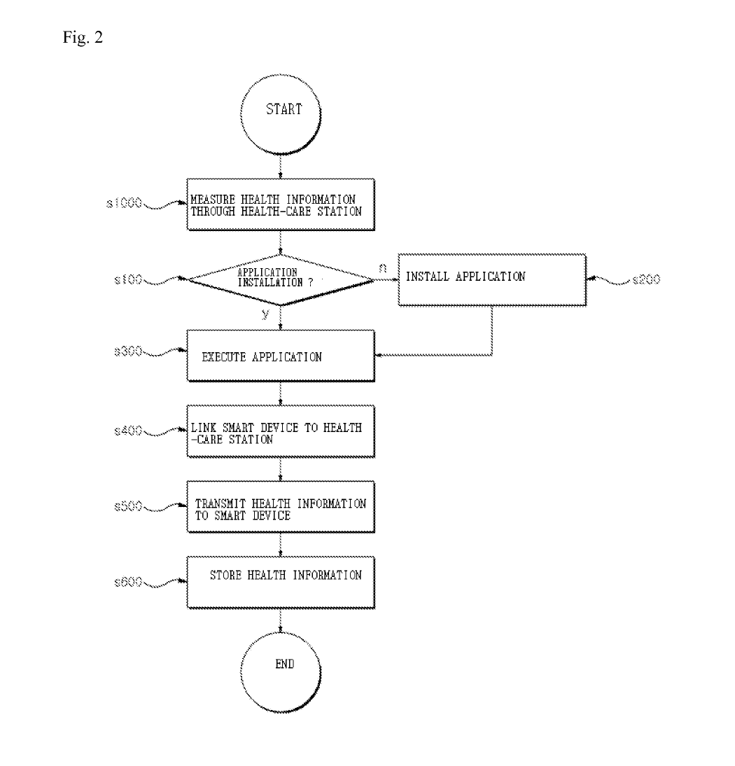

The present invention relates to a technology for measuring and managing health information, and more particularly to a method and a system for measuring and managing health information by using a health-care station. FIG. 1 is a conceptual diagram showing a health information management system using a health-care station and a personal mobile terminal in accordance with the present invention. FIG. 2 is a flowchart for describing a method for measuring and managing the health information in accordance with the present invention.

The present invention provides a method for measuring and managing health information by using a health-care station. The method includes:

(i) checking whether or not a health-care station linked application is installed in a health-care station 100 linked personal mobile terminal 200 (s100);

(ii) installing the health-care station linked application in the personal mobile terminal 200 when the health-care station 100 linked application is not installed (s200);

(iii) executing the health-care station 100 linked application (s300);

(iv) linking the health-care station 100 to the personal mobile terminal 200 in which the health-care station 100 linked application has been executed (s400);

(v) transmitting measured health information to the personal mobile terminal 200 from the health-care station 100 (s500); and

(vi) storing the transmitted health information in the personal mobile terminal 200 (s600).

The health-care station 100 of the present invention is commonly available to a large number of users. It is preferable that the health-care station 100 has a shape like a Kiosk.

It is preferable that the step (ii) of installing the health-care station linked application in the personal mobile terminal 200 when the health-care station 100 linked application is not installed includes:

recognizing a Quick Response (QR) code 70 provided from the health-care station 100 by the personal mobile terminal 200 so as to guide the personal mobile terminal 200 to an application download server (s210);

downloading the health-care station linked application corresponding to the QR code, from the linked application download server (s220); and

installing the downloaded application in the terminal (s230). Through the use of the QR code, the application can be quickly and easily installed.

In another embodiment, the step (s200) of installing the health-care station linked application in the personal mobile terminal 200 when the health-care station 100 linked application is not installed may also include a method for directly transmitting the application stored in the health-care station 100 to the personal mobile terminal 200 and installing without use of the QR code or other download servers.

The step (s400) of linking the health-care station 100 to the personal mobile terminal 200 in which the health-care station 100 linked application has been executed may use at least one selected from the wired/wireless connection method consisting of Bluetooth, USB, HDMI, Near Field Communication (NFC), Wifi and RFID. A user is also allowed to select his/her desired connection method for convenience.

The step (s400) of linking the health-care station 100 to the personal mobile terminal 200 in which the health-care station 100 linked application has been executed may include authenticating the user (s410). Since the health-care station 100 and the personal mobile terminal 200 are one-to-one linked to each other and the health information is not stored in the health-care station 100, the step (s410) of authenticating the user is not indispensable and thus may be omitted.

The step (s500) of transmitting measured health information to the personal mobile terminal 200 from the health-care station 100 can be performed by using at least one selected from the wired/wireless connection method consisting of Bluetooth, USB, HDMI, Near Field Communication (NFC) and Wifi.

Prior to the step (s100) of checking whether or not the health-care station linked application is installed in the health-care station 100 linked personal mobile terminal 200, it is preferable to measure the health information through the use of respective measuring devices 300 connected to the health-care station 100 (s1000).

In the above embodiment, there is an advantage of immediately measuring the health information before linking the application of the personal mobile terminal 200.

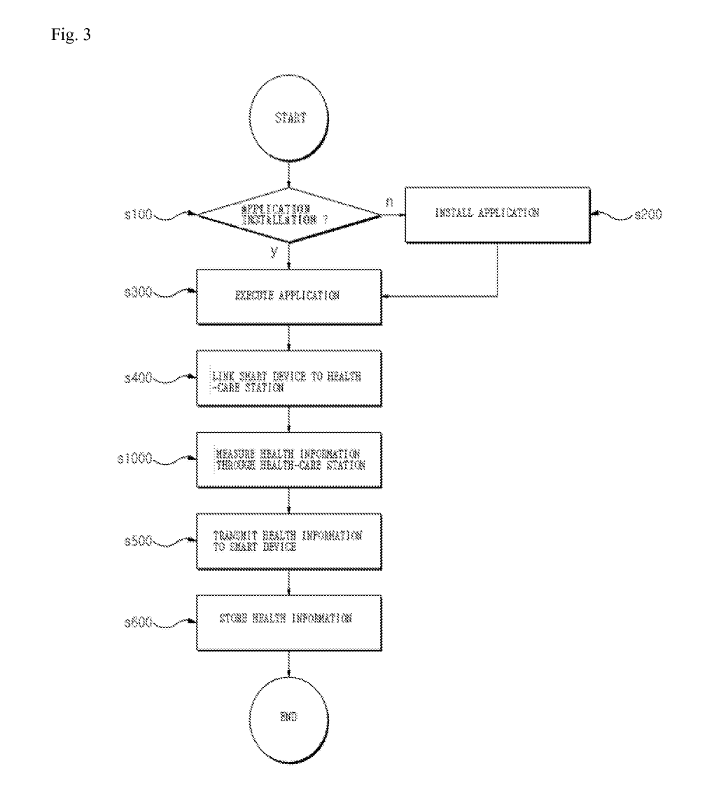

Additionally, as shown in FIG. 3, after the step (s400) of linking the health-care station 100 to the personal mobile terminal 200 in which the health-care station 100 linked application has been executed, it is also possible to perform the step (s1000) of measuring the health information through the use of the respective measuring devices 300 connected to the health-care station 100.

It is preferable that the personal mobile terminal 200 is a smart device including a smart phone, a tablet PC, a smart watch, a smart glass and a smart player.

After the step (s600) of storing the transmitted health information in the personal mobile terminal 200, it is preferable to add displaying the health information stored in the personal mobile terminal 200 to the user (s700). Here, it is preferable for the step (s700) of displaying the health information stored in the personal mobile terminal 200 to the user to include displaying a guideline generated from a guideline generation module 283 of the personal mobile terminal 200 (s710).

In one embodiment, the guideline may be in advance stored in a database 281 and the stored guideline may be outputted according to the analysis result of a health information analysis module 282.

That is to say, the measured health information is stored in the database 281 of the personal mobile terminal 200, and the user is allowed to make a reference to the health information. Additionally, in further another embodiment, after the step (s600) of storing the transmitted health information in the personal mobile terminal 200, the personal mobile terminal 200 may be managed by an external medical institution with the inclusion of a step of transmitting the stored health information to a health information management server 1000 by the personal mobile terminal 200 (s800).

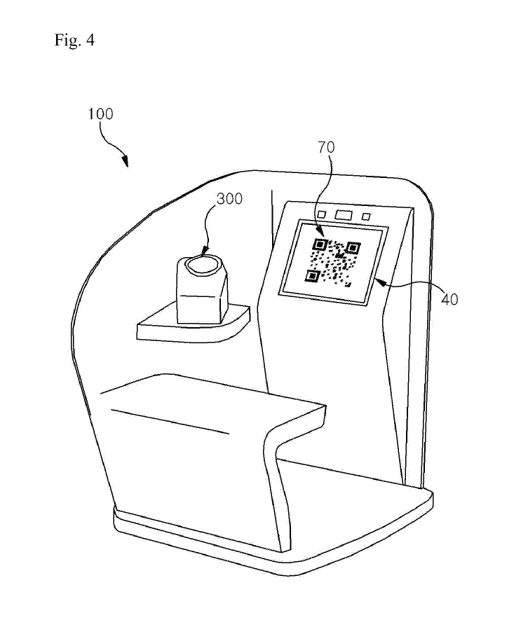

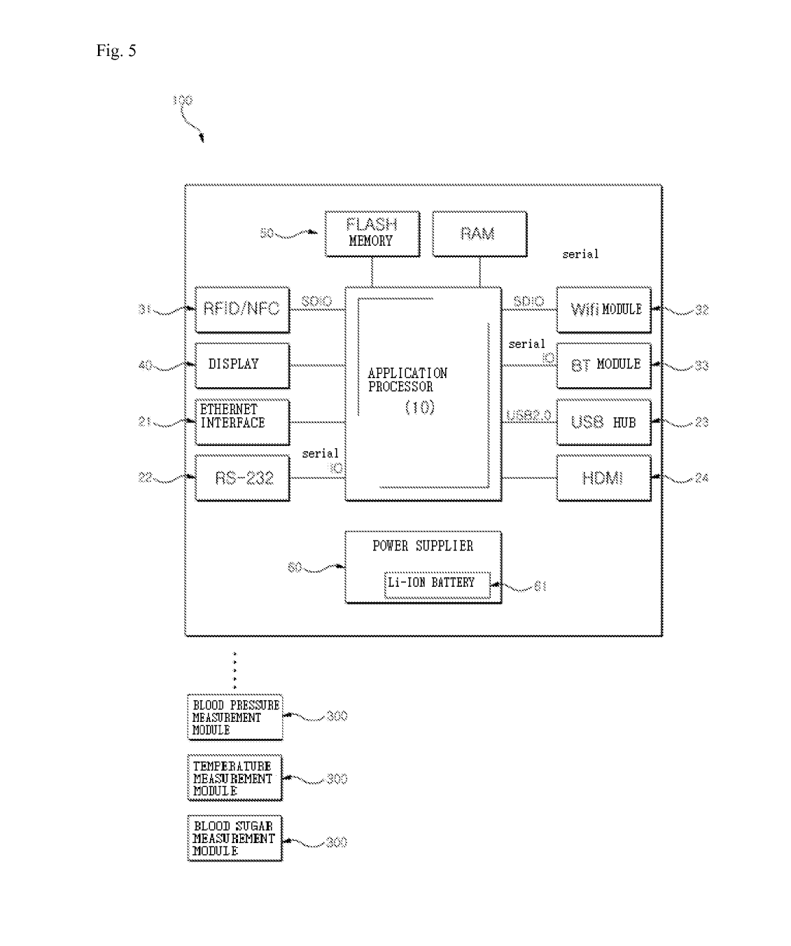

In the present invention, as shown in FIGS. 4 and 5, the health-care station for measuring and managing the health information includes an application processor 10 for processing the health information and controlling each module, wired/wireless communication units 20 and 30 for connecting the each health information measuring device 300 to the personal mobile terminal 200, a display unit 40 for displaying the measurement result of the health information and the health status, a memory 50, and a power supplier 60 for supplying power.

It is preferable that the wired communication unit 20 includes at least one selected from the group consisting of Ethernet interface 21, Recommended Standard (RS)-232 22, USB hub 23 and HDMI 24, and the wireless communication unit 30 includes at least one selected from the group consisting of RFID/NFC 31, a WiFi module, and a Bluetooth module.

The power supplier 60 may include a rechargeable battery 61 on order to improve the mobility of the Kiosk.

Also, the health-care station 100 may include the QR code for providing guidance to the server where the linked application can be downloaded. It is preferable that the QR code may be printed and attached to the outside of the health-care station 100 or may be displayed by the display unit 40.

As described above, it is preferable that the personal mobile terminal 200 that is linked to the health-care station is any one selected from a smart device including a smart phone, a tablet PC, a smart watch, a smart glass, and a smart player.

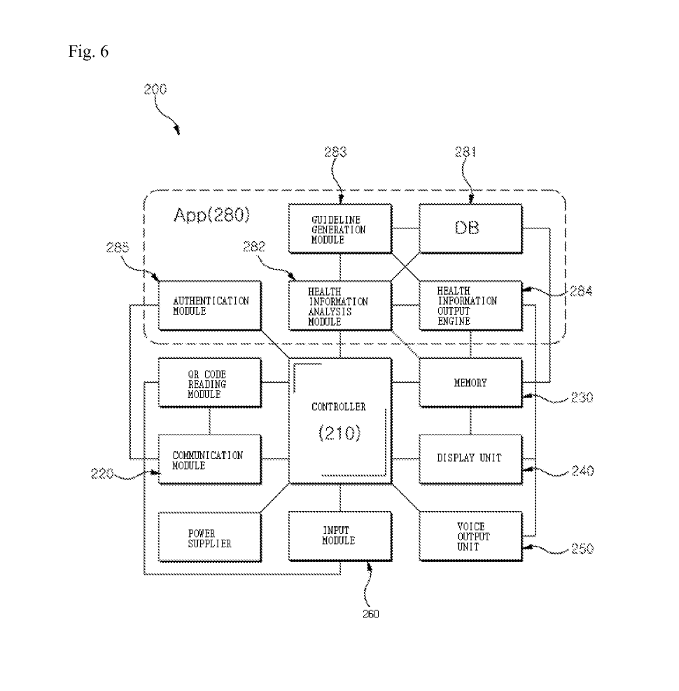

As shown in FIG. 6, it is preferable that the personal mobile terminal 200 includes a controller 210 for controlling the device, a communication module 220 for communicating with the health-care station 100, a memory 230 for storing the health information data received from the health-care station 100, a display unit 240 for displaying the information including the health information, a voice output unit 250 for outputting the information including the health information in the form of voice, an input module 260 for allowing users to input, a QR code reading module 270 for reading the QR codes, and an application 280 which is a software for managing the health information.

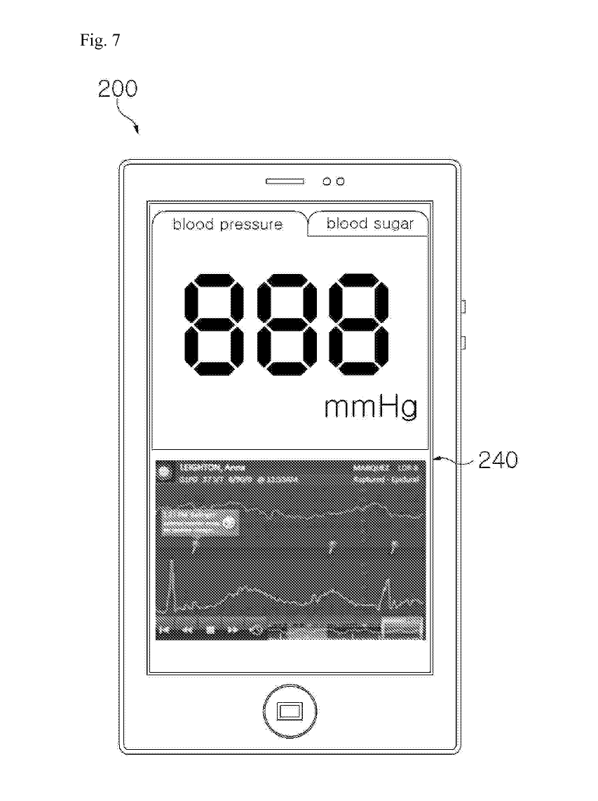

The application 280 may include the database (DB) 281 for storing the health information, the health information analysis module 282 for analyzing the health information stored in the database 281, the guideline generation module 283 for generating the guideline according to the analyzed result, a health information output engine 284 for outputting the image/sound of the health information, and a health-care station authentication module 285 for authenticating the user when the personal mobile terminal 200 is linked to the health-care station 100. FIG. 7 is a view showing a display of the personal mobile terminal of the present invention.

In other words, the system for measuring and managing the health information in accordance with the present invention includes the above-mentioned health-care station 100 which includes the application processor 10 for processing the health information and controlling each module, the wired/wireless communication units 20 and 30 for connecting the each health information measuring device 300 to the personal mobile terminal 200, the display unit 40 for displaying the measurement result of the health information and the health status, the memory 50, and the power supplier 60 for supplying power, and includes the personal mobile terminal 200 which is linked to the health-care station 100.

The personal mobile terminal 200 includes the controller 210, the communication module 220 for communicating with the health-care station 100, the memory 230 for storing the health information data received from the health-care station 100, the display unit 240 for displaying the information including the health information, the voice output unit 250 for outputting the information including the health information in the form of voice, the input module 260 for allowing users to input, the QR code reading module 270 for reading the QR codes, and the application 280 which is a software for managing the health information.

Also, moreover, the present invention includes further another embodiment where the health information management server 1000 which receives the health information from the personal mobile terminal 200 is added to the system. The embodiment includes the step (s800) of transmitting the stored health information to the health information management server 1000 by the personal mobile terminal 200. The personal mobile terminal 200 may be managed on-line by an external medical institution operating the health information management server 1000.

The present invention has been described with reference to the accompanying drawings. This is just one of various embodiments including the subject matter of the present invention and intends to allow those skilled in the art to easily embody the present invention. It is clear that the present invention is not limited to the above-described embodiments. Therefore, the scope of the present invention should be construed by the following claims. Without departing from the subject matter of the present invention, all the technical spirits within the scope equivalent to the subject matter of the present invention is included in the right scope of the present invention by the modifications, substitutions, changes and the like. Also, it is clear that some of the drawing configuration are intended for more clearly describing the configuration and are more exaggerated or shortened than the actual one.

What is claimed is:

1. A method for managing health information by using a health-care station, the method comprising:
(i) checking whether or not a health-care station linked application is installed in a health-care station 100 linked personal mobile terminal 200 (s100);
(ii) installing the health-care station linked application in the personal mobile terminal 200 when the health-care station 100 linked application is not installed (s200);
(iii) executing the health-care station 100 linked application (s300);
(iv) linking the health-care station 100 to the personal mobile terminal 200 in which the health-care station 100 linked application has been executed (s400);
(v) transmitting measured health information to the personal mobile terminal 200 from the health-care station 100 (s500); and
(vi) storing the transmitted health information in the personal mobile terminal 200 (s600).

2. The method of claim 1, wherein the step (s200) of installing the health-care station linked application in the personal mobile terminal 200 when the health-care station 100 linked application is not installed comprises:
recognizing a Quick Response (QR) code 70 provided from the health-care station 100 by the personal mobile terminal 200 so as to guide the personal mobile terminal 200 to an application download server (s210);
downloading the health-care station linked application corresponding to the QR code, from the linked application download server (s220); and
installing the downloaded application in the terminal (s230).

3. The method of claim 1, wherein the step (s200) of installing the health-care station linked application in the personal mobile terminal 200 when the health-care station 100 linked application is not installed comprises a method for directly transmitting the application stored in the health-care station 100 to the personal mobile terminal 200 and installing the application.

4. The method of claim 1, wherein the step (s400) of linking the health-care station 100 to the personal mobile terminal 200 in which the health-care station 100 linked application has been executed uses at least one selected from the wired/wireless connection method consisting of Bluetooth, USB, HDMI, Near Field Communication (NFC), Wifi and RFID.

5. The method of claim 1, wherein the step (s400) of linking the health-care station 100 to the personal mobile terminal 200 in which the health-care station 100 linked application has been executed comprises authenticating the user (s410).

6. The method of claim 1, wherein the step (s500) of transmitting measured health information to the personal mobile terminal 200 from the health-care station 100 is performed by using at least one selected from the wired/wireless connection method consisting of Bluetooth, USB, HDMI, Near Field Communication (NFC) and Wifi.

7. The method of claim 1, wherein, prior to the step (s100) of checking whether or not the health-care station linked application is installed in the health-care station 100 linked personal mobile terminal 200, comprising measuring the health information through the use of respective measuring devices 300 connected to the health-care station 100 (s1000).

8. The method of claim 1, wherein, after the step (s400) of linking the health-care station 100 to the personal mobile terminal 200 in which the health-care station 100 linked application has been executed, comprising performing the step (s1000) of measuring the health information through the use of the respective measuring devices 300 connected to the health-care station 100.

9. The method of claim 1, wherein the personal mobile terminal 200 is a smart device including a smart phone, a tablet PC, a smart watch, a smart glass and a smart player.

10. The method of claim 1, wherein, after the step (s600) of storing the transmitted health information in the personal mobile terminal 200, adding displaying the health information stored in the personal mobile terminal 200 to the user (s700).

11. The method of claim 10, wherein the step (s700) of displaying the health information stored in the personal mobile terminal 200 to the user comprises displaying a guideline generated from a guideline generation module 283 of the personal mobile terminal 200 (s710).

12. The method of claim 1, wherein, after the step (s600) of storing the transmitted health information in the personal mobile terminal 200, comprising transmitting the stored health information to a health information management server 1000 by the personal mobile terminal 200 (s800).

13. A health-care station for managing health information comprises an application processor 10 for processing the health information and controlling each module, wired/wireless communication units 20 and 30 for connecting the each health information measuring device 300 to a personal mobile terminal 200, a display unit 40 for displaying the measurement result of the health information and the health status, a memory 50, and a power supplier 60 for supplying power.

14. The health-care station of claim 13, wherein the wired communication unit 20 comprises at least one selected from the group consisting of Ethernet interface 21, Recommended Standard (RS)-232 22, USB hub 23 and HDMI 24.

15. The health-care station of claim 13, wherein the wireless communication unit 30 comprises at least one selected from the group consisting of RFID/NFC 31, a Wifi module 32, and a Bluetooth module 33.

16. The health-care station of claim 13, wherein the power supplier 60 comprises a rechargeable battery 61.

17. The health-care station of claim 13, wherein the health-care station 100 comprises a QR code 70 for providing guidance to the server where the linked application downloadable, and wherein the QR code 70 is printed and attached to the outside of the health-care station 100 or is displayed by the display unit 40.

18. A personal mobile terminal 200 that is linked to a health-care station comprises a controller 210 for controlling a device, a communication module 220 for communicating with a health-care station 100, a memory 230 for storing health information data received from the health-care station 100, a display unit 240 for displaying the information including the health information, a voice output unit 250 for outputting the information including the health information in the form of voice, an input module 260 for allowing users to input, a QR code reading module 270 for reading a QR code 70, and an application 280 that is a software for managing the health information.

19. The personal mobile terminal 200 of claim 18, wherein the application 280 comprises a database (DB) 281 for storing the health information, a health information analysis module 282 for analyzing the health information stored in the database 281, a guideline generation module 283 for generating the guideline according to the analyzed result, a health information output engine 284 for outputting the image/sound of the health information, and a health-care station authentication module 285 for authenticating the user when the personal mobile terminal 200 is linked to the health-care station 100.

20. A health information management system using both the health-care station 100 for managing the health information and the personal mobile terminal 200, the system comprising:
the health-care station 100 of any one claim of claims 13 to 17, which includes the application processor 10 for processing the health information and controlling each module, the wired/wireless communication units 20 and 30 for connecting the each health information measuring device 300 to the personal mobile terminal 200, the display unit 40 for displaying the measurement result of the health information and the health status, the memory 50, and the power supplier 60 for supplying power; and
the personal mobile terminal 200 which is linked to the health-care station,
wherein the personal mobile terminal 200 comprises a controller 210, a communication module 220 for communicating with the health-care station 100, a memory 230 for storing the health information data received from the health-care station 100, a display unit 240 for displaying the information including the health information, a voice output unit 250 for outputting the information including the health information in the form of voice, an input module 260 for allowing users to input, a QR code reading module 270 for reading the QR codes, and an application 280 which is a software for managing the health information.

21. A health information management system using both the health-care station 100 for managing the health information and the personal mobile terminal 200, the system comprising:
the health-care station 100 of any one claim of claims 13 to 17, which includes the application processor 10 for processing the health information and controlling each module, the wired/wireless communication units 20 and 30 for connecting the each health information measuring device 300 to the personal mobile terminal 200, the display unit 40 for displaying the measurement result of the health information and the health status, the memory 50, and the power supplier 60 for supplying power;
the personal mobile terminal 200 which is linked to the health-care station and comprises a controller 210, a communication module 220 for communicating with the health-care station 100, a memory 230 for storing the health information data received from the health-care station 100, a display unit 240 for displaying the information including the health information, a voice output unit 250 for outputting the information including the health information in the form of voice, an input module 260 for allowing users to input, a QR code reading module 270 for reading the QR codes, and an application 280 which is a software for managing the health information; and
a health information management server 1000 which receives the health information from the personal mobile terminal 200.
